(19) United States
(12) Patent Application Publication
(10) Pub. No.: US 2026/0023682 A1
(43) Pub. Date: Jan. 22, 2026

(54) DYNAMIC QUALITY BENCHMARK ASSESSMENT FOR AUTOMATED TESTING OF LLM-BASED CHATBOTS

(71) Applicant: Dell Products L.P., Round Rock, TX (US)

(72) Inventors: David Burth Kurka, Campinas (BR); Victor da Cruz Ferreira, Rio de Janeiro (BR); Vinicius Michel Gottin, Rio de Janeiro (BR)

(21) Appl. No.: 18/780,211

(22) Filed: Jul. 22, 2024

(51) Int. Cl. G06F 11/36; G06F 11/34; H04L 51/02

(52) U.S. Cl. CPC G06F 11/3692; G06F 11/3428; G06F 11/3688; H04L 51/02

(57) ABSTRACT

One example method for evaluating a quality of chatbot answers after changes have been made to internal chatbot pre-processing tasks and/or post-processing tasks, includes filtering, based on information identifying changes that have been made to a reference version of a chatbot, a set of representative questions that have been posed by one or more users to the reference version of the chatbot, to obtain a test set of test questions related to the changes, obtaining test answers, generated by a new version of the chatbot, to the test questions, scoring the test answers, and performing an automated testing process that includes comparing scores of the test answers with scores of answers provided by the reference version of the chatbot to the test questions.

### TECHNOLOGICAL FIELD OF THE DISCLOSURE

Some embodiments disclosed herein generally relate to LLM-based chatbots. More particularly, at least some embodiments relate to systems, hardware, software, computer-readable media, and methods, for assessing, and modifying, the performance of an LLM-based chatbot.

### BACKGROUND

Chatbots are ubiquitous and can provide valuable assistance to a user, and insights to the host of the chatbot, if the chatbot is properly trained, configured, and operated. The problem at hand is that, during the process of development, the pre-processing and post-processing tasks in the chatbot are subject to constant change, and assessing whether those changes impact the overall quality of the chatbot is an open problem. Additionally, any such evaluation and assessment must ideally provide insights into how the chatbot was changed, and which cases, such as types of queries for example, are most affected.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses Retrieval Augment Generation (RAG) Chatbot minimal steps.

FIG. 2 discloses the structure of a chatbot C with pre- and post-processing tasks.

FIG. 3 discloses the process of answer generation to one embodiment, wherein a an answer Aⁱ is produced by a previous version Cⁱ, and a new answer Aⁱ⁺¹ is produced by a augmented chatbot Cⁱ⁺¹ derived from Cⁱ, for a same question Q.

FIG. 4 discloses the collection of a database Di relating user queries, answers provided by the chatbot, and human feedback, according to one embodiment.

FIG. 5 discloses identification of similar questions and the determination of representative questions, according to one embodiment.

FIG. 6 discloses computer perplexity scores Pⁱ for the answers in Aⁱ, according to one embodiment.

FIG. 7 discloses obtaining answers for the test set Dⁱ⁺¹, according to one embodiment.

FIG. 8 discloses comparing the test answer to all the answers for reference question, according to one embodiment.

FIG. 9 discloses computation of a score for the test answer based on the comparison of its perplexity score and the perplexity score(s) for the reference question when the reference score is positive, according to one embodiment.

FIG. 10 discloses computation of a score for the test answer based on the comparison of its perplexity score and the perplexity score(s) for the reference question when the reference score is negative, according to one embodiment.

FIG. 11 discloses an example method according to one embodiment.

FIG. 12 discloses a computing entity configured and operable to perform any of the disclosed methods, processes, and operations.

### DETAILED DESCRIPTION OF SOME EXAMPLE EMBODIMENTS

Some embodiments disclosed herein generally relate to LLM-based chatbots. More particularly, at least some embodiments relate to systems, hardware, software, computer-readable media, and methods, for assessing, and modifying, the performance of an LLM-based chatbot, or simply ‘chatbot.’

Example embodiments include methods for assessing and modifying the performance of an LLM-based chatbot. Performance scores for an LLM-based chatbot may be computed, and compared, both online, and offline. An embodiment may provide for creation and maintenance of a database that relates queries and answers collected with human feedback. The database may be managed with human feedback annotation to enable efficiency and correctness in score computations. A method according to one embodiment may be performed offline, and another method may be performed online.

A method according to one embodiment may comprise the operations: in an offline stage: scoring reference questions that may be obtained from a database of human feedback; determining representative questions; filtering the reference questions; performing a similarity aggregation on the filtered reference questions; and, calculation perplexity scores for each answer to a question in a reference version of the LLM-based chatbot; and, in an online stage that may be used to generate a new version of the LLM-based chatbot: obtaining and filtering a test set of available questions; obtaining answers to the available questions; scoring the answers; and, performing automated testing of the quality of the changes from the reference version of the LLM-based chatbot to the new version of the LLM-based chatbot.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that score computation methods are provided that may be employed in an offline stage, and in an online stage. An embodiment may provide for the management of a database with human feedback annotation for efficiency and correctness in score computations. An embodiment may leverage a dynamic quality benchmark for the automated evaluation of LLM-based chatbots after internal changes to the LLM-based chatbots during pre- and post-processing operations. An embodiment may assess whether pre- and post-processing changes occurring during development of an LLM-chatbot impact the overall quality of the LLM-chatbot answers. An embodiment may provide insights into how the LLM-based chatbot was changed, and which cases, such as types of queries for example, are (most) affected. Various other advantages of one or more example embodiments will be apparent from this disclosure.

### A. CONTEXT FOR AN EXAMPLE EMBODIMENT

The following is a discussion of aspects of a context for an example embodiment. This discussion is not intended to limit the scope of the claims or this disclosure, or the applicability of the embodiments, in any way.

### A.1 Chatbot Architecture

Current iterations of chatbots rely on LLMs (large language models) to understand the user question constraints and semantic meaning of the question. Independently, several pre-processing steps follow to better digest the question and formulate a good input prompt for LLM. Different prompts can greatly modify the LLM generated output. Furthermore, the generated output may also go under some additional post-processing steps to evaluate if the answer is valid.

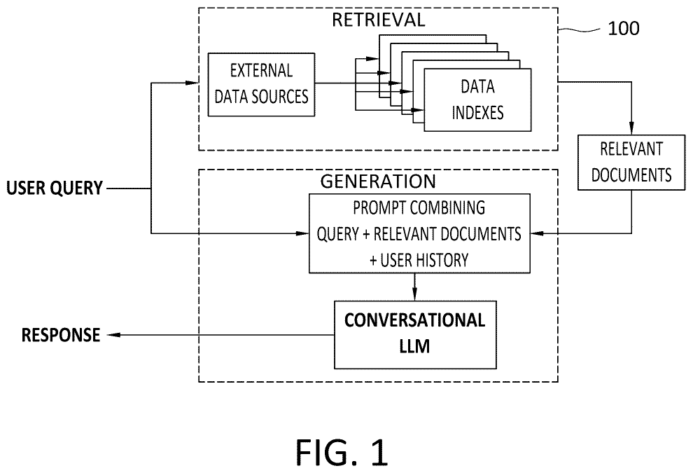

For the purposes of comparison with an example embodiment, FIG. 1 shows an approach to chatbots called Retrieval Augmented Generation (RAG) 100. RAG approaches are more pre/post processing intensive as they rely on retrieved sources/data attached to the LLM input prompt to guide its response. Therefore, relying on the LLM to find the answer with internal knowledge and context information.

### A.2 Perplexity

Perplexity is a popular metric when evaluating token generated LLM responses. It is calculated with the exponentiated negative averaged log likelihood of all words in a sentence. As seen below:

$$PPL = exp \{ - \frac{1}{t} {\sum }_{i}^{t} log {p}_{θ} ( {x}_{i} \vert {x}_{< i} ) \}$$

where t represents the number of tokens generated for the sentence and subscript i is the ith token. Intuitively, it can be viewed as how ‘surprised’ the LLM, or simply ‘model,’ is on seeing the current data. This measurement is highly dependent on how well the model was trained, as a model with a high range of tokens and well internalized/learned structured of several topics will likely produce a lower perplexity value.

### A.3 Semantic Similarity

It is commonplace when developing standard software to use different functions that compare two or more strings by taking the character or word by face value. However, when dealing with Natural Language Processing (NLP) and LLMs, such naïve comparisons fail to capture the semantic meaning behind the phrases and words.

For example, consider the two sentences: “I used to park my car” and “I used my car to the park.” Notice how these strings use similar words and may yield a high similarity score on naïve approaches but have different semantic meaning.

Semantic similarity measures look to solve this issue by considering context information and conveying the semantic meaning of the sentences into a measurable format. One practice is to use LM model specialized in embedding generation, such as BERT variations or All-MiniLLM, to convert a set of tokens or sentence into a numerical embedding space. The embedding space will capture semantic meaning over the sentence which allows for a sentence a and b to be measured using a distance function Q(a, b), such as cosine similarity, to determine if the two given sentences are semantically similar.

### B. OVERVIEW OF ASPECTS OF AN EMBODIMENT

One example embodiment comprises an approach for leveraging a dynamic quality benchmark for the automated evaluation of LLM-based chatbots after internal changes. An embodiment may enable automated testing of a LLM-based chatbot, to ensure, without human supervision, that the quality of conversations conducted by the LLM-based chatbot is not adversely affected by changes to internal pre- and post-processing tasks performed in the development of the LLM-based chatbot.

An embodiment may comprise the following mechanisms for obtaining scores of a chatbot for multiple representative questions from a database containing previously collected human feedback: (1) a first mechanism for obtaining scores for a reference version of a chatbot, processed over said database in offline fashion; and (2) a second mechanism for obtaining scores for the same set of questions for a new version of the chatbot, in online fashion, that is, at the time of the automated testing of the LLM-based chatbot.

The comparison between the global scores for the reference and testing versions of the LLM-based chatbot may be used to validate or invalidate the changes, which an embodiment may leverage into automated testing capabilities that can be implemented into MLOps (DevOps (software development and IT operations) for machine learning systems) and CI/CD (continuous integration/continuous delivery) pipelines.

An embodiment further comprises, in addition to the aforementioned first mechanism and second mechanism, all related orchestration and processing necessary to complete the method for automated testing, including: (1) the obtaining and management of a database relating queries and answers, collected with human feedback; (2) the discovery and assignment of representative questions for groups of similar questions; and (3) the aggregation of the scores of individual and of representative questions into global scores for the reference and new versions of the chatbot.

Thus, one example embodiment comprises a method for orchestrating and effecting automated testing of the quality of the results generated by an LLM-based chatbot, in response to one or more user questions or inquiries, after changes to the internal pre- and post-processing tasks of the LLM-based chatbot. One or more embodiments of such a method may comprise various score computation methods, which may be implemented in offline and/or online modes. Further, an embodiment may provide for the management of a database with human feedback annotation for efficiency and correctness in our score computation.

### C. DETAILED DISCUSSION OF ONE OR MORE EXAMPLE EMBODIMENTS

### C.1 Context

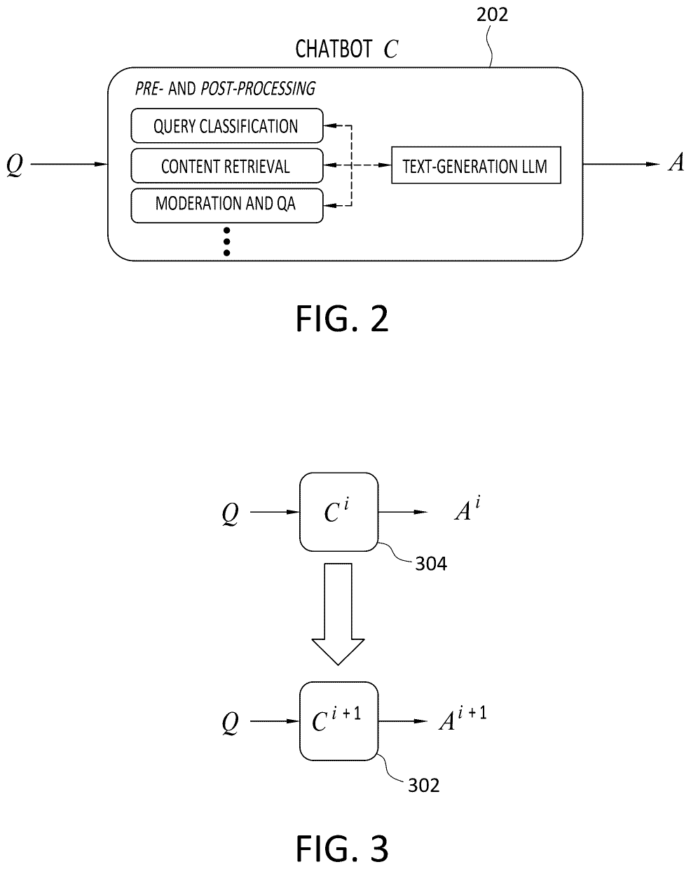

With reference now to the example of FIG. 2, which discloses the structure of an LLM-based chatbot C 202 with pre- and post-processing tasks, consider that the LLM-based chatbot C 202 may have a typical structure of performing pre-processing tasks over a user query Q to produce the context for a text-generation LLM, and then performing post-processing tasks over the raw output of the LLM to yield an answer A to be presented by the user.

Typical pre-processing tasks, as shown in FIG. 2, may include, for example, moderation, query classification, content retrieval, and prompt formatting. Typical post-processing tasks include hallucination detection, summarization and many tasks related to presenting the answer by way of, for example, a GUI (graphical user interface). Many other kinds of tasks are possible.

For the purposes of the present discussion, pre-processing tasks and post-processing tasks are denominated that may take place independently of the text-generation LLM. These tasks might use other LLMs internally, but do not interfere in the text-generation itself, only on its inputs and outputs. In one embodiment, there is a requirement that there must be the ability to relate the queries Q posed by a user to the answers A yielded by the chatbot.

An embodiment may consider the scenario in which these pre- and post-processing tasks change as result of the development process of the LLM-based chatbot, and it becomes necessary to determine whether those changes have adversely affected the quality of the answers provided by the LLM-based chatbot. This scenario is illustrated in FIG. 3.

Particularly, FIG. 3 discloses aspects of a problem that may be resolved by one embodiment, namely, determining, in an automated and replicable fashion, whether a new answer Aⁱ⁺¹ produced by a modified chatbot Cⁱ⁺¹ 302 is substantially worse than the answer Aⁱ produced by a previous version Cⁱ 304 for a set of reference questions Q.

For a new version Cⁱ⁺¹ of a same chatbot Cⁱ, new answers will be obtained for the same set of questions Q. Given that chatbot answers are unconstrained text sentences, the quality assessment itself is challenging, and understanding whether changes have improved, or not impacted, the quality of the chatbot performance in terms of its answers is difficult-naïve comparisons between answer sets are not applicable, that is, string- or edit-distance comparisons, as explained earlier herein. Thus, an embodiment may comprise scoring mechanisms to enable such comparisons and extend this mechanism for the automated testing of sequential versions of a chatbot, capable of reporting for which questions the quality of the answers has dropped in the new version of the chatbot.

### C.2 Reference Questions Scoring

The first stage of one embodiment relies on a database containing human feedback respective to the reference version Ci of a chatbot. Particularly, an embodiment may determine groups of similar questions, extracting only representative questions from each group, and then compute a normalized perplexity score for each answer to those questions.

### C.2.1 Human Feedback Database

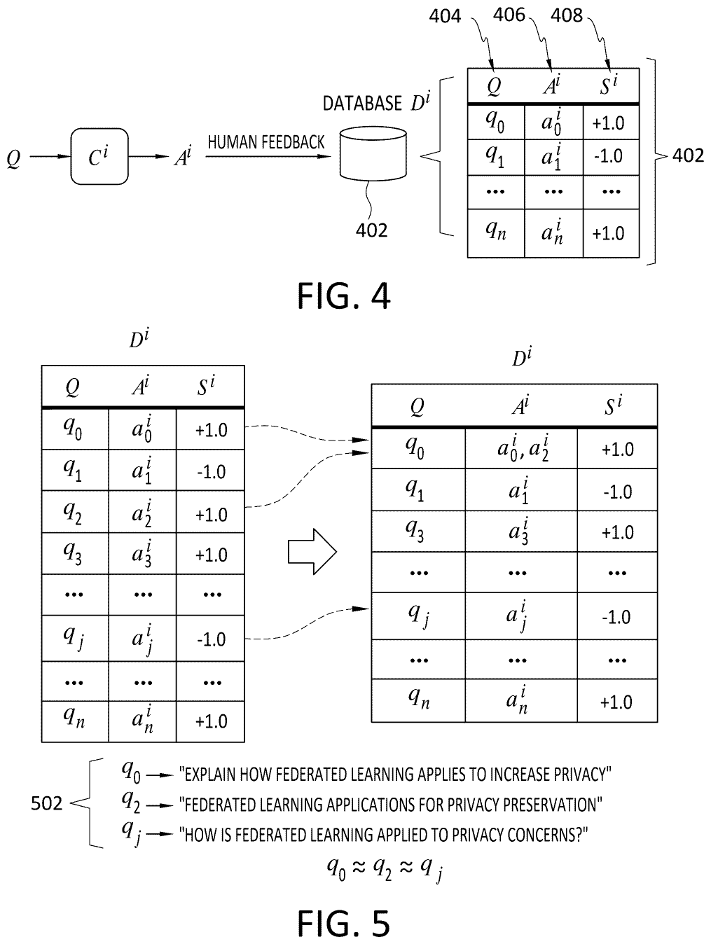

As typical in the operation of chatbots, one embodiment may assume that feedback is collected over time on a deployed environment, that is, an environment in which the chatbot is deployed. Multiple kinds of feedback can be collected, either from usage or from explicit revision and annotation efforts. One embodiment assumes a database containing simple feedback, as in the example of FIG. 4.

In particular, FIG. 4 discloses the collection of a database Dⁱ 402 relating user queries 404, answers 406 provided by the chatbot, and human feedback 408. In FIG. 4, and the following discussion, an embodiment may assume the simplest form of feedback (also typical in chatbot applications)-binary feedback (+1, “thumbs up”; or −1, “thumbs down”).

### C.2.2 Determining Representative Questions

One possible issue is that this database Dⁱ 402 (see FIG. 4) can grow very large over time, especially if it is not managed across versions of the chatbot, that is, if Dⁱ⊆Dⁱ⁺¹. To manage this, one embodiment may perform two kinds of reduction, namely, filtering, and aggregation. Both relate to the concepts that may be selected, for testing procedures, questions based on relevance, coverage and/or uniqueness in the domain.

### C.2.2.1 Filtering

For filtering, one embodiment may be concerned with the relevance of the questions for the automated testing pipeline. This may mean an embodiment may need to obtain certain questions that changed scores from one version to the other, based on a monitoring of the database D over sequential versions of the chatbot, that is, comparing Dⁱ to Dⁱ⁺¹, to be tested. In an embodiment, this determination may rely on metadata assigned to the entries in Dⁱ. This is discussed below part of the orchestration for the automated testing.

Another filtering aspect used in one embodiment is that of recency, with oldest questions and answers pruned from the database over time. This determination may be subject to considerations of uniqueness—that is, unique questions should not be pruned if they are still relevant. This relates to a metric of similarity between questions, discussed below.

### C.2.2.2 Similarity Aggregation

It is often the case that a user, or multiple users, may repeat similar interactions with the chatbot, providing individual feedback each time. Thus, one embodiment may identify similar questions and elect one question as a representative question of a group of questions. An example of this is depicted in FIG. 5.

In particular, FIG. 5 discloses an example approach for the identification of similar questions and the determination of representative questions. The similarity computation requires a well-defined similarity function Z(a, b) over questions a and b. While similarity metrics can be used, an embodiment may assume Z considers semantic similarity. To that end, such embodiment may rely on a LM, albeit not the same text-generation LLM used by the chatbot; or one of established libraries and frameworks for such.

In the example of FIG. 5, the questions 502, namely, q₀, q₂ and qᵢ, are considered similar because they refer to a same core concept, “Federated Learning” in this example, with respect to a similar context. Another possibility is to leverage internal metadata from the chatbot execution to, at least partially, determine this similarity. In the case the chatbot performs content retrieval as one of its preprocessing tasks, these sentences could be determined to be likely similar because they fetch the same set of documents from an external database, such as a vector database encoding the content of the sources. In such cases, Z may consider multiple factors, with the similarity of fetched sources being one of the factors considered—to avoid false positives, that is, similar sources for different questions.

Given sets of mutually similar questions, an embodiment may elect a representative question from a set of similar questions. This may depend on the particular similarity function. For example, if the similarity function yields a distance metric, the questions can be clustered, and those questions closest to each centroid can be selected. Otherwise, a straightforward method is to take each question qᵢ in Q iteratively as a representative question, then checking all other questions qₖ for similarity to it. If Z(qᵢ, qₖ) determines they are similar, an embodiment may check if they have the same, or similar as noted below, scores, that is, if

$${S}_{j}^{i} \tilde{=} {S}_{k}^{i} .$$

If so, an embodiment may add the answer

$${A}_{k}^{i} to {A}_{j}^{i} ,$$

and remove row K Trom the table.

In one embodiment, the election of representative questions process takes place offline, but if computational costs are a concern, another possibility is that of just taking a random choice from each set of similar questions. Regardless of the method applied, it should result in Dⁱ holding a one-to-many relationship between questions and answers, and an embodiment may store all the answers of all related questions.

An embodiment may employ the notation Aⁱ[j] to represent the j-th element of the answers Aⁱ in database Dⁱ. That is, Aⁱ[j] is an answer or a list of answers for question qᵢ in database Dⁱ. In the example of FIG. 5, the representative question q₀ has answers

$$[ {A}^{i} [ 0 ] = [ {a}_{0}^{i} , {a}_{2}^{i} ] .$$

It is noted that an embodiment does not coalesce questions with differing scores. Question qᵢ in the example is not aggregated with q₀ and q₂ despite being similar, because its answer

$${a}_{j}^{i}$$

has a negative score.

In the case of binary scores this check is straightforward. That is, an embodiment may only allow groups of questions with identical scores. In cases where numerical scores are allowed, for example, real values between −1 and 1, an embodiment may allow questions with scores similar up to a threshold to be aggregated, changing Sⁱ[j] (the j-th score Sⁱ, associated to question qᵢ in Dⁱ) to be the average scores of all aggregated answers.

### C.2.3 Perplexity Scores

The last process in one embodiment of an offline stage is to compute an additional score, pᵢ, for the answer(s) to each question in the reference version of the chatbot, that is, with respect to Dⁱ. This score will reflect the perplexity of the answer(s) as considered by the text-generation LLM, that is, the average log probability per token in the answer given the question as context.

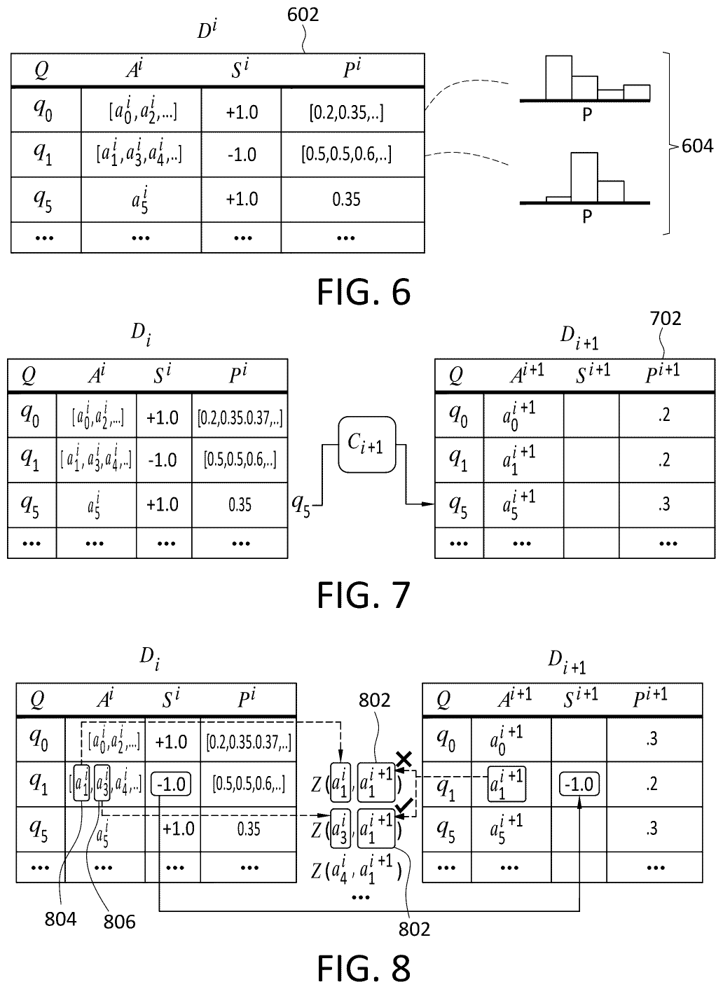

An intuition underlying this approach is that an embodiment should indicate that changes in the chatbot that increase the surprise of the answer, as judged by the LLM, are more likely to be unsuitable, causing drop in quality. A similar intuition is used by commercially available language models APIs for determining which among of multiple answers to a question is ‘best’ as disclosed in “OpenAI, ‘OpenAI API reference,’ 2023.” This document, incorporated herein in its entirety, is at https://platform.openai.com/docs/guides/production-best-practices/number-of-completion-tokens. An embodiment may compute the perplexity score for each answer in Dⁱ. This is represented in FIG. 6, which discloses computer perplexity scores Pⁱ for the answers in Aⁱ.

Particularly, FIG. 6 indicates how, in one embodiment, a perplexity score is computed for each answer related to each question. For representative questions with multiple answers in Dⁱ 602 (e.g., q0, q1) an embodiment may obtain a histogram 604 of the perplexity scores. For questions with a single answer, a single perplexity score is obtained. As discussed below, embodiment of an automated testing process deals with both cases.

### C.3 Test Questions Scoring

Consider now an iterative process of development that generates a new version of the chatbot Cⁱ⁺¹ derived from Cⁱ with changes to its internal pre- and post-processing tasks. The processes described herein aim at composing a “test set” table Dⁱ⁺¹, comparable to the Dⁱ described above, but with respect to the new version of the chatbot. This test set may be built without human intervention. The comparison between both tables can be used for the automated testing for determining whether the quality of the chatbot has degraded and, if so, for which questions.

### C.3.1 Obtaining a Test Set

### C.3.1.1 Test-Time Filtering

A first consideration is that an embodiment may further filter the set of available questions at test time—in addition to the filtering described above. From all the representative questions in Dⁱ, which may have already been filtered and aggregated, an embodiment May further select only a subset of those filtered/aggregated questions by leveraging information that is only available at test time, such as, for example, based on information of which changes were made to the chatbot. That is, if a pre- or post-processing task is known to be changed and there is a way to determine which questions are most related to that task, an embodiment may filter Dⁱ to contain only, or preferentially, those questions.

A filtering process performed at test time may also rely on an expected processing time. The table Di may be filtered to a maximum of m entries, from its original n, based on an estimate of time-to-process for each question and the maximum processing time for the test procedures.

### C.3.1.2 Obtain Test Answers

Regardless of whether test-time filtering is performed or not, an embodiment may proceed to obtain answers for the remaining questions in Dⁱ. This is a straightforward processing of the new version of the chatbot for each question, and one example is disclosed in FIG. 7.

Particularly, FIG. 7 discloses an approach for obtaining answers for the test set Dⁱ⁺¹ 702. With this processing, an embodiment may obtain an answer aⁱ⁺¹ for each qⱼ∈Q. The perplexity score of the answer may be directly obtained as part of the answer-generation process. Thus, an embodiment may assume, as represented in FIG. 7, that the corresponding value Pⁱ⁺¹[j] is also obtained. At this point, the scores of the answers in Dⁱ⁺¹ 702 are still not set. The computation of those values is discussed below.

### C.3.2 Test Answer Scoring

In an embodiment, the scoring of the answers may proceed as follows. Particularly, an embodiment may comprise the performance of two tasks: first, the embodiment may reuse the original scores, from the human feedback, when similar answers are provided, whether positive or negative; and, second, for the remaining questions, an embodiment may compute a proportional test score based on the perplexity scores.

### C.3.2.1 Similar Answers

For each question qᵢ ∈Q, an embodiment may compare answer

$${a}_{j}^{i + 1}$$

to each aₖ∈

$${A}_{j}^{i} .$$

A goal in this embodiment is to ‘reuse’ the scores for similar answers as those obtained in the reference set Sⁱ. This is disclosed in FIG. 8.

In particular, FIG. 8 discloses an example process of comparing the test answer to all the answers for reference question. If the test answer

$${a}_{j}^{i + 1}$$

is similar to at least one or aₖ ∈Ai[j], an embodiment may assign the score Sⁱ⁺¹[j] to be equal to Sⁱ[j]. This is also depicted in FIG. 8. In the example, the test answer

$${a}_{1}^{i + 1}$$

802 is not similar to the first reference answer

$${a}_{1}^{i}$$

804. Thus, an embodiment may check the next one and find, for example, that

$${a}_{1}^{i + 1}$$

802 is similar to

$${a}_{3}^{i}$$

806. As a result, an embodiment may copy the score of Sⁱ[j](−1) to Sⁱ⁺¹[j]. In this example, there may be no need to check aⁱ, since the test answer being similar to one of the reference answers is sufficient.

FIG. 8 again refers to a similarity function Z, which may be similar to the one described earlier herein. Particularly in this case, the similarity function Z may comprise a string similarity metric, or edit distance.

### C.3.2.2 Perplexity-Based Proportional Score

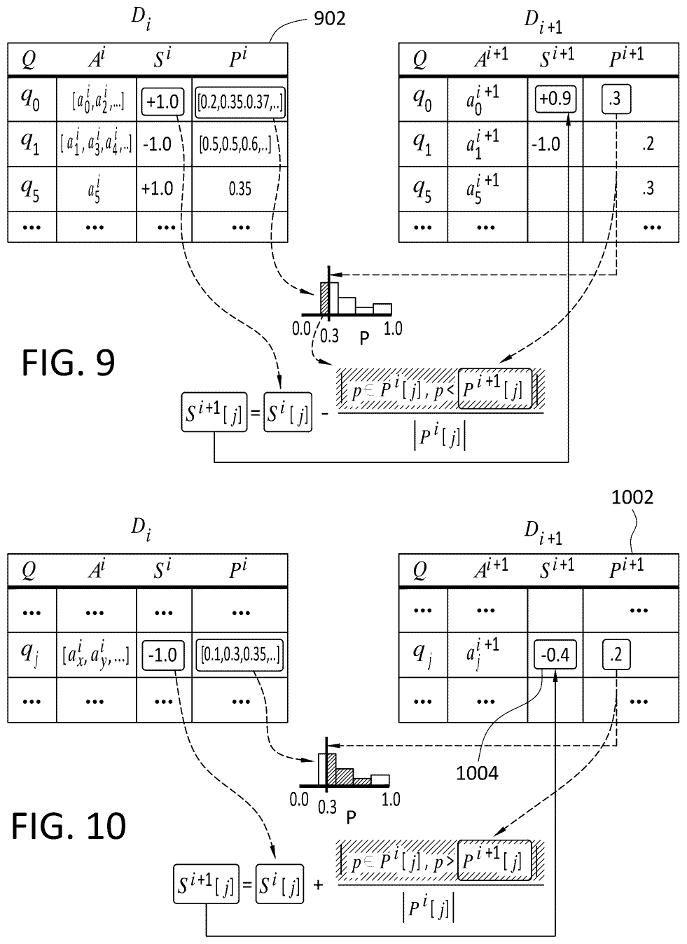

For each question qⱼ∈Q that is not yet scored, that is, not scored from a similar reference answer, an embodiment may compute a pondered scored based on the comparison of the perplexity scores of the test answer and the reference answer(s) of the same question. This is shown, for the case where the question has a positive score in the reference table Dⁱ, in FIG. 9.

In particular, FIG. 9 discloses that, in an embodiment, a score for the test answer is computed based on the comparison of its perplexity score and the perplexity score(s) for the reference question. If the question has a positive score in the reference table Dⁱ 902, an embodiment may compute the test score also as positive, that is, the score of the reference answer(s) minus the proportion of answers in the reference table Dⁱ 902 with a lower perplexity score:

$${S}^{i + 1} [ j ] = {S}^{i} [ j ] - \frac{\vert p ∈ {P}^{i} [ j ] , p < {P}^{i + 1} [ j ] \vert}{\vert {P}^{i} [ j ] \vert}$$

It is noted that when a question qⱼ has a single answer in the reference table Dⁱ 902, and therefore a single perplexity value Pⁱ[j], the resulting score Sⁱ⁺¹[j] will be either equal to the reference score Sⁱ[j] or zero. For questions that have a negative score in the reference table Dⁱ 902, an embodiment may compute the score based on the proportion of answers in the reference table with a higher perplexity score, as shown in FIG. 10:

$${S}^{i + 1} [ j ] = {S}^{i} [ j ] - \frac{\vert p ∈ {P}^{i} [ j ] , p > {P}^{i + 1} [ j ] \vert}{\vert {P}^{i} [ j ] \vert}$$

In particular, FIG. 10 discloses that, in one embodiment, a score for the test answer is computed based on the comparison of its perplexity score and the perplexity score(s) for the reference question. This means that if there were known bad answers with a certain perplexity, and the new answer is different from those known bad answers, an embodiment may consider that the new answer is an improvement over the previous answers, at least to the extent that the LLM believes the new answer is most predictable. In the case where the reference answers had a negative score despite having a very low perplexity, the proportional score in the test table Dⁱ⁺¹ 1002 will tend towards −1 anyway as shown at 1004, indicating that there may be little room for improvement in the score. An embodiment may obtain smaller negative scores in the cases where the negatively scored answers have, in general, higher perplexity, meaning that the mechanisms in the chatbot are confounding the LLM.

### C.4 Automated Testing

An embodiment may leverage a reference table Dⁱ and a resulting test table Dⁱ⁺¹ for automated testing of the quality of the changes from the chatbot from version Cⁱ to Cⁱ⁺¹. AN embodiment may compute an aggregated score for each table, and may rely on the comparison between such aggregated scores to determine whether the test passes or fails.

In one embodiment, the computation of the aggregate scores for each table can take any appropriate form. A straightforward way is to take the average scores Sⁱ and Sⁱ⁺¹, respectively. The comparison for validating the results of the test may require a tolerance threshold k, such that the test fails only if Sⁱ⁺¹+k<Sⁱ.

An embodiment may additionally provide explainability functionalities. For example, an embodiment may select: (1) questions with originally negative scores for which the new scores are substantially better, that is, the new scores have smaller negative values; and (2) questions with originally positive scores for which the new scores are substantially worse, that is, the new scores have smaller positive values, and then showing to the user, such as a developer or reviewer for example, the question, the change in the answer(s) and the respective change in scores. The latter case may be particularly useful for providing insights as to how confident the test is that the new version does not degrade the performance of the chatbot in situations where the chatbot worked well previously. This is a case of particular interest for ensuring the quality of the chatbot over time, across multiple versions.

Finally, an embodiment may use the selected questions to inform the process of filtering representative questions. If the test passes, an embodiment may keep track of the questions selected above, both throughout the chatbot deployment and the continuous human feedback collection mechanism. An embodiment may add metadata to the feedback collected to indicate that these questions are of particular interest for future testing, ensuring that they are prioritized in further filtering and for collection of human feedback.

### D. EXAMPLE METHODS

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

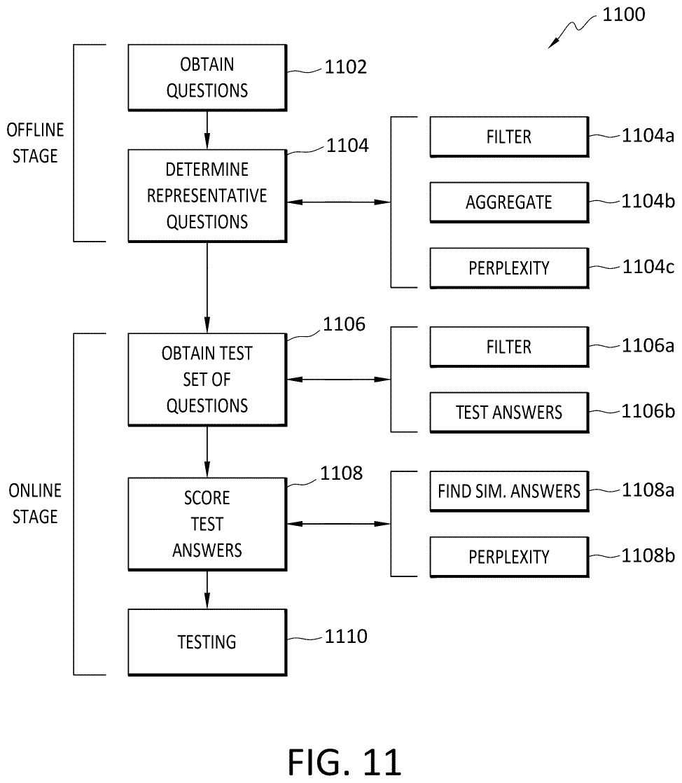

Directing attention now to FIG. 11, an example embodiment of a method 1100 is disclosed. The example method 1100 may comprise an offline stage and an online stage. The offline and online stages may, or may not, be performed at different respective sites. The method 1100 may be performed in connection with various types of chatbots including, but not limited to, LLM-based chatbots. In an embodiment, both the offline and online stages may be implemented by an entity, such as a business or commercial entity for example, that controls creation, modification, deployment, and use, of a chatbot.

The example method 1100 may begin with an offline stage in which, initially, various questions may be obtained 1102 from a database. These may be questions previously asked by one or more users, and answered by a chatbot. The answers may be stored in the database in association with the corresponding questions.

From the group of questions, one or more representative questions may be determined 1104. In an embodiment, determination 1104 of the representative questions may comprise filtering 1104a the questions to identify the most relevant questions, then aggregating 1104b the filtered questions to identify similar questions, and generating 1104c respective perplexity scores for the answers to each question in the reference, or initial, version of the chatbot.

At this point, the online stage of the method 1100 may be complete. Thus, the method 1100 may enter an online stage that may begin with obtaining 1106 a test set of questions, such as from the database. In an embodiment, obtaining 1106 a test set of questions may comprise filtering 1106a the set of representative questions obtained at 1104 and then obtaining 1106b test answers for the filtered 1106a set of questions.

Next, the test answers may be scored 1108. In an embodiment, scoring 1108 the test answers may comprise finding 1108a similar answers to the answers obtained for the questions in the reference set, and then scoring 11080b any questions not yet scored.

Finally, testing 1110 may be performed. In an embodiment, the testing 1110 may comprise automated testing of the quality of the changes, or answers, provided by, respectively, the reference version of the chatbot, and the new version of the chatbot. Thus, the testing 1110 may provide an indication as to whether the answers provided by the new version of the chatbot are better, or worse, than those provided by the reference version of the chatbot. Depending upon the outcome of the testing 1110, the reference version of the chatbot may, or may not, be replaced in a production, or deployed, environment with the new version of the chatbot.

### E. FURTHER EXAMPLE EMBODIMENTS

Following are some further example embodiments. These are presented only by way of example and are not intended to limit the scope of this disclosure or the claims in any way.

Embodiment 1. A method for evaluating a quality of chatbot answers after changes have been made to internal chatbot pre-processing tasks and/or post-processing tasks, comprising: filtering, based on information identifying changes that have been made to a reference version of a chatbot, a set of representative questions that have been posed by one or more users to the reference version of the chatbot, to obtain a test set of test questions related to the changes; obtaining test answers, generated by a new version of the chatbot, to the test questions; scoring the test answers; and performing an automated testing process that comprises comparing scores of the test answers with scores of answers provided by the reference version of the chatbot to the test questions.

Embodiment 2. The method as recited in any preceding embodiment, wherein the chatbot comprises an LLM (large language model)-based chatbot.

Embodiment 3. The method as recited in any preceding embodiment, wherein a set comprising the test questions and the test answers is built without human involvement.

Embodiment 4. The method as recited in any preceding embodiment, wherein the comparing indicates whether or not a change has occurred between a quality of the answers generated by the reference version of the chatbot, and a quality of the test answers generated by the new version of the chatbot.

Embodiment 5. The method as recited in any preceding embodiment, wherein the changes to the reference version of the chatbot comprise changes to internal chatbot pre-processing tasks and/or post-processing tasks.

Embodiment 6. The method as recited in any preceding embodiment, wherein one or more of the test answers are scored using a similarity function.

Embodiment 7. The method as recited in any preceding embodiment, wherein one or more of the test answers are scored based on a comparison of respective perplexity scores of the one or more test answers and the answers generated by the reference version of the chatbot.

Embodiment 8. The method as recited in any preceding embodiment, wherein the comparing scores of the test answers with scores of answers provided by the reference version of the chatbot to the test questions comprises comparing respective aggregate scores of a reference table of a database and a test table of the database, and the reference table comprises the test questions and the answers generated by the reference version of the chatbot, and the test table comprises the test questions and the answers generated by the new version of the chatbot.

Embodiment 9. The method as recited in any preceding embodiment, wherein, based on the comparing, either the new version of the chatbot is deployed to a production environment in place of the reference version of the chatbot, or the reference version of the chatbot remains in the production environment and is not replaced with the new version of the chatbot.

Embodiment 10. The method as recited in any preceding embodiment, wherein, after the comparing, a report is generated that explains, for a given one of the test questions, a change in the test answer relative to the answer generated by the reference version of the chatbot, and also explains any changes in the scores of the answers provided by the reference version of the chatbot.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### F. EXAMPLE COMPUTING DEVICES AND ASSOCIATED MEDIA

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

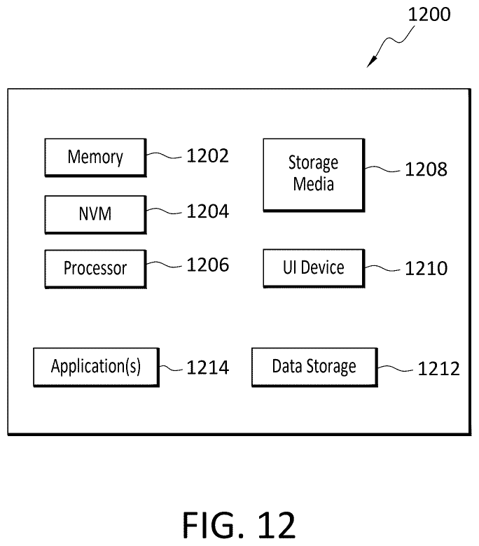

With reference briefly now to FIG. 12, any one or more of the entities disclosed, or implied, by FIGS. 1-11, and/or elsewhere herein, may take the form of, or include, or be implemented on, or hosted by, a physical computing device, one example of which is denoted at 1200. As well, where any of the aforementioned elements comprise or consist of a virtual machine (VM), that VM may constitute a virtualization of any combination of the physical components disclosed in FIG. 12.

In the example of FIG. 12, the physical computing device 1200 includes a memory 1202 which may include one, some, or all, of random access memory (RAM), non-volatile memory (NVM) 1204 such as NVRAM for example, read-only memory (ROM), and persistent memory, one or more hardware processors 1206, non-transitory storage media 1208, UI device 1210, and data storage 1212. One or more of the memory components 1202 of the physical computing device 1200 may take the form of solid state device (SSD) storage. As well, one or more applications 1214 may be provided that comprise instructions executable by one or more hardware processors 1206 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method for evaluating a quality of chatbot answers after changes have been made to internal chatbot pre-processing tasks and/or post-processing tasks, comprising:
filtering, based on information identifying changes that have been made to a reference version of a chatbot, a set of representative questions that have been posed by one or more users to the reference version of the chatbot, to obtain a test set of test questions related to the changes;
obtaining test answers, generated by a new version of the chatbot, to the test questions;
scoring the test answers, wherein one or more of the test answers are scored based on a comparison of respective perplexity scores of the one or more test answers and the answers generated by the reference version of the chatbot; and
performing an automated testing process that comprises comparing scores of the test answers with scores of answers provided by the reference version of the chatbot to the test questions.

2. The method as recited in claim 1, wherein the chatbot comprises an LLM (large language model)-based chatbot.

3. The method as recited in claim 1, wherein a set comprising the test questions and the test answers is built without human involvement.

4. The method as recited in claim 1, wherein the comparing indicates whether or not a change has occurred between a quality of the answers generated by the reference version of the chatbot, and a quality of the test answers generated by the new version of the chatbot.

5. The method as recited in claim 1, wherein the changes to the reference version of the chatbot comprise changes to internal chatbot pre-processing tasks and/or post-processing tasks.

6. The method as recited in claim 1, wherein one or more of the test answers are scored using a similarity function.

7. The method as recited in claim 1, wherein the comparing scores of the test answers with scores of answers provided by the reference version of the chatbot to the test questions comprises comparing respective aggregate scores of a reference table of a database and a test table of the database, and the reference table comprises the test questions and the answers generated by the reference version of the chatbot, and the test table comprises the test questions and the answers generated by the new version of the chatbot.

8. The method as recited in claim 1, wherein, based on the comparing, either the new version of the chatbot is deployed to a production environment in place of the reference version of the chatbot, or the reference version of the chatbot remains in the production environment and is not replaced with the new version of the chatbot.

9. The method as recited in claim 1, wherein, after the comparing, a report is generated that explains, for a given one of the test questions, a change in the test answer relative to the answer generated by the reference version of the chatbot, and also explains any changes in the scores of the answers provided by the reference version of the chatbot.

10. A non-transitory storage medium having stored therein instructions that are executable by one or more hardware processors to:
perform operations that implement a method for evaluating a quality of chatbot answers after changes have been made to internal chatbot pre-processing tasks and/or post-processing tasks, the operations comprising:
filtering, based on information identifying changes that have been made to a reference version of a chatbot, a set of representative questions that have been posed by one or more users to the reference version of the chatbot, to obtain a test set of test questions related to the changes;
obtaining test answers, generated by a new version of the chatbot, to the test questions;
scoring the test answers, wherein one or more of the test answers are scored based on a comparison of respective perplexity scores of the one or more test answers and the answers generated by the reference version of the chatbot; and
performing an automated testing process that comprises comparing scores of the test answers with scores of answers provided by the reference version of the chatbot to the test questions.

11. The non-transitory storage medium as recited in claim 10, wherein the chatbot comprises an LLM (large language model)-based chatbot.

12. The non-transitory storage medium as recited in claim 10, wherein a set comprising the test questions and the test answers is built without human involvement.

13. The non-transitory storage medium as recited in claim 10, wherein the comparing indicates whether or not a change has occurred between a quality of the answers generated by the reference version of the chatbot, and a quality of the test answers generated by the new version of the chatbot.

14. The non-transitory storage medium as recited in claim 10, wherein the changes to the reference version of the chatbot comprise changes to internal chatbot pre-processing tasks and/or post-processing tasks.

15. The non-transitory storage medium as recited in claim 10, wherein one or more of the test answers are scored using a similarity function.

16. The non-transitory storage medium as recited in claim 10, wherein the comparing scores of the test answers with scores of answers provided by the reference version of the chatbot to the test questions comprises comparing respective aggregate scores of a reference table of a database and a test table of the database, and the reference table comprises the test questions and the answers generated by the reference version of the chatbot, and the test table comprises the test questions and the answers generated by the new version of the chatbot.

17. The non-transitory storage medium as recited in claim 10, wherein, based on the comparing, either the new version of the chatbot is deployed to a production environment in place of the reference version of the chatbot, or the reference version of the chatbot remains in the production environment and is not replaced with the new version of the chatbot.

18. The non-transitory storage medium as recited in claim 10, wherein, after the comparing, a report is generated that explains, for a given one of the test questions, a change in the test answer relative to the answer generated by the reference version of the chatbot, and also explains any changes in the scores of the answers provided by the reference version of the chatbot.
